(19) United States
(12) Patent Application Publication
(10) Pub. No.: US 2026/0301415 A1
(43) Pub. Date: Oct. 1, 2026

(54) DATA ALIGNMENT METHOD AND INTELLIGENT VEHICLE

(71) Applicant: Wistron Corporation, New Taipei City (TW)

(72) Inventor: Hsiao Wen Tin, New Taipei City (TW)

(73) Assignee: Wistron Corporation, New Taipei City (TW)

(21) Appl. No.: 19/181,365

(22) Filed: Apr. 17, 2025

(30) Foreign Application Priority Data
Mar. 27, 2025 (TW) 114111707

(51) Int. Cl. G06V 20/56; G06T 3/40; G06V 10/74; G06V 20/40

(52) U.S. Cl. CPC G06V 20/56; G06T 3/40; G06V 10/761; G06V 20/49

(57) ABSTRACT

The present disclosure proposes a data alignment method and an intelligent vehicle. The method includes: obtaining a road environment video through an image capturing device on the intelligent vehicle; determining a current driving mode to determine a prompt and a test frame; inputting the road environment video and the prompt into a language model to segment the road environment video into multiple clips; calculating a similarity between each frame in the clips and the test frame to determine a first time point; obtaining sensor data through a sensor on the intelligent vehicle and generating a one-dimensional signal based on the sensor data; obtaining an extremum value of the one-dimensional signal within a window at the first time point, wherein the extremum value occurs at a second time point; and aligning the road environment video with the sensor data based on the first and second time points.

### CROSS-REFERENCE TO RELATED APPLICATION

This application claims the priority benefit of Taiwan application serial no. 114111707, filed on Mar. 27, 2025. The entirety of the above-mentioned patent application is hereby incorporated by reference herein and made a part of this specification.

### BACKGROUND

### Technical Field

This disclosure relates to a data alignment method for various sensors on an intelligent vehicle.

### Related Art

Autonomous driving technology has received substantial investment and development in recent years. According to the standards of the Society of Automotive Engineers (SAE), autonomous driving technology can be classified from Level 0 to Level 5, where Advanced Driver Assistance Systems (ADAS) play an important role in lower-level autonomous driving by assisting drivers to improve driving safety. However, complete Automated Driving Systems (ADS) rely on sensors, artificial intelligence algorithms and other technologies to make decisions, which may achieve fully autonomous driving without driver intervention at higher levels (Level 4-5).

As the level of autonomous driving increases, the amount of data that vehicles need to process and store also increases significantly. For example, Level 2 vehicles require approximately 4-10 PB of data, while Level 5 vehicles need at least 3 EB of storage space. These enormous amounts of data present great challenges for sensor data processing, transmission, and fusion. In existing technology, some vehicle manufacturers mainly adopt pure vision solutions, relying on cameras for environmental sensing, while some other manufacturers adopt diverse sensor technologies such as radar, lidar, and ultrasonic sensors to enhance sensing capabilities in different environments. However, the data formats of various sensors are different; for example, cameras provide image data, radar generates 3D point cloud data, and ultrasonic sensors provide distance information. Therefore, the alignment and fusion of multiple sensor data has become a key challenge in the development of autonomous driving technology.

### SUMMARY

To solve the above problems, this disclosure proposes a data alignment method and intelligent vehicle.

This disclosure proposes a data alignment method applicable to intelligent vehicles. This data alignment method includes: obtaining a road environment video through an image capturing device on the intelligent vehicle; determining a current driving mode from multiple driving modes of the intelligent vehicle, and determining a first prompt and a test frame according to the current driving mode; inputting the road environment video and the first prompt to a language model to segment the road environment video into multiple clips, where each clip contains multiple frames; for one of the clips, calculating the similarity between each corresponding frame and the test frame, thereby determining a first time point of the clip; obtaining sensing data through a sensor on the intelligent vehicle, and generating a one-dimensional signal according to the sensing data; obtaining an extreme value of the one-dimensional signal within a window at the first time point, where the extreme value occurs at a second time point; and aligning the road environment video and the sensing data according to the first time point and the second time point.

From another perspective, the embodiment of this disclosure proposes an intelligent vehicle, including a processor, an image capturing device, and a sensor. The image capturing device is configured to obtain road environment video, and the sensor is configured to obtain sensing data. The processor is electrically connected to the image capturing device and the sensor, and is configured to execute the data alignment method described above.

To make the above features and advantages of this invention more clearly understandable, embodiments are provided below with detailed explanations in conjunction with the accompanying drawings.

### BRIEF DESCRIPTION OF THE DRAWINGS

FIG. 1 is a schematic diagram illustrating an intelligent vehicle according to an embodiment.

FIG. 2 is a system block diagram illustrating an intelligent vehicle according to an embodiment.

FIG. 3 is a flowchart illustrating a data alignment method according to an embodiment.

FIG. 4 is an example of a test frame according to an embodiment.

FIG. 5 is a flowchart illustrating an alternative to step 303 according to another embodiment.

FIG. 6 is a schematic diagram illustrating the calculation of feature vectors according to an embodiment.

FIG. 7 is a schematic diagram illustrating the alignment of sensor data and road environment video according to an embodiment.

FIG. 8 is a schematic diagram illustrating the result after time displacement according to an embodiment.

### DESCRIPTION OF THE EMBODIMENTS

Some embodiments of the present invention will now be described in detail with reference to the accompanying drawings. In the following description, when the same reference numerals appear in different drawings, they will be regarded as the same or similar components. These embodiments are only part of the invention and do not disclose all possible implementations of the invention. More precisely, these embodiments are examples of systems and methods within the scope of the patent claims of the present invention.

Regarding the terms “first,” “second,” etc. used in this document, they do not specifically indicate order or sequence, but are merely used to distinguish components or operations described with the same technical terminology.

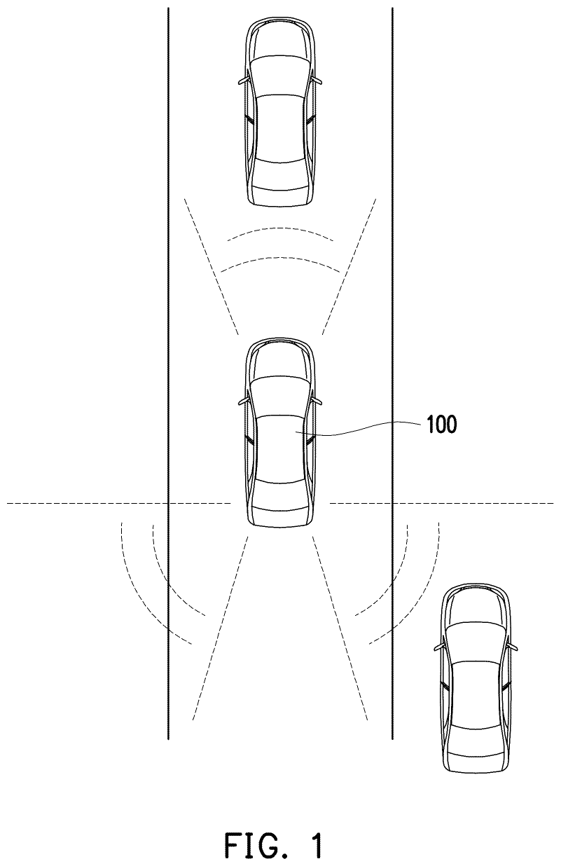

FIG. 1 is a schematic diagram illustrating an intelligent vehicle according to an embodiment. Referring to FIG. 1, the intelligent vehicle 100 refers to a vehicle equipped with an advanced driving assistance system, autonomous driving system, or other intelligent systems. The intelligent vehicle 100 is equipped with various sensors to sense different types of environment information.

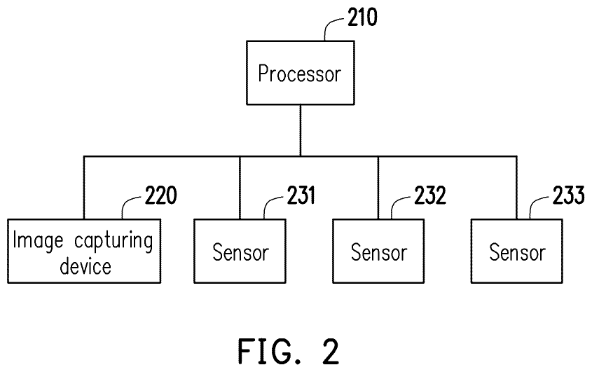

FIG. 2 is a system block diagram illustrating an intelligent vehicle according to an embodiment. Referring to FIG. 2, the intelligent vehicle 100 includes a processor 210, an image capturing device 220, and multiple sensors 231-233, wherein the processor 210 is electrically connected to the image capturing device 220 and the sensors 231-233. The processor 210 may include a central processing unit, graphics processing unit, microprocessor, microcontroller, image processing chip, deep-learning processing unit (DPU), neural network processing unit (NPU), tensor processing unit (TPU), Application Specific Integrated Circuits (ASIC), Programmable Logic Device (PLD), etc. The image capturing device 220 may include a Charge-coupled Device (CCD) sensor, Complementary Metal-Oxide Semiconductor (CMOS) sensor, or other suitable photosensitive components. The sensors 231-233 include, for example, LiDAR, radar, ultrasonic sensors, etc. This disclosure does not limit the number and installation positions of the image capturing device 220 and sensors 231-233. For example, the image capturing device 220 may be installed on the front windshield, rear of the vehicle, and left and right sides; LiDAR may be installed on the roof, front, and rear of the vehicle; radar and ultrasonic sensors may be installed on the front bumper, rear bumper, and left and right sides.

The image capturing device 220 captures video (also referred to as road environment video), while data (referred to as sensor data) generated by other sensors may include point clouds or various values (such as distance, speed and angle). However, these videos and sensor data may not be synchronized, so the processor 210 executes a data alignment method to align the timelines of these videos and sensor data with each other.

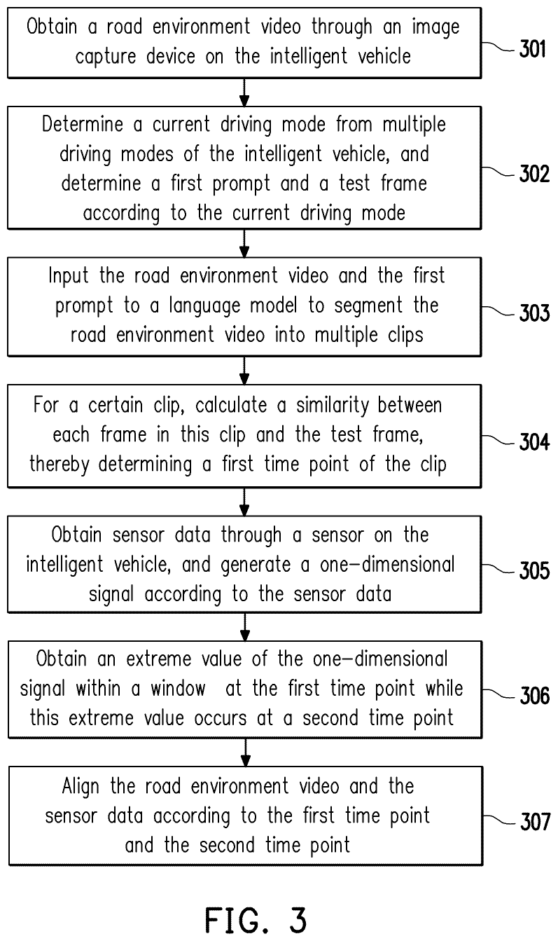

FIG. 3 is a flowchart illustrating a data alignment method according to an embodiment. In step 301, the road environment video is obtained through the image capturing device 220 on the intelligent vehicle 100. This road environment video may be video of the front, right, left, or rear, with no restrictions on the position and capture direction of the image capturing device 220.

In step 302, a current driving mode is determined from multiple driving modes of the intelligent vehicle 100, and a first prompt and a test frame are determined according to the current driving mode. The driving mode is determined based on the driving status of the intelligent vehicle 100 or whether specific functions are activated. In some embodiments, the intelligent vehicle 100 includes Adaptive Cruise Control (ACC) system, Rear Cross Traffic Alert System (RCTA), Lane Departure Warning System (LDWS), Forward Collision Warning (FCW) system, Automatic Emergency Braking (AEB) system, Lane Keeping Assist (LKA) system, Blind Spot Detection (BSD) system, etc., and whether each system is activated (or issues warnings) may correspond to a different driving mode. The intelligent vehicle 100 has at least 4 gear positions: P, R, N, D, and different gear positions may correspond to different driving modes in some embodiments. In some embodiments, the driving modes are determined based on vehicle speed. In this embodiment, the established driving modes include at least Adaptive Cruise Control (ACC) mode, reverse mode, and turning mode.

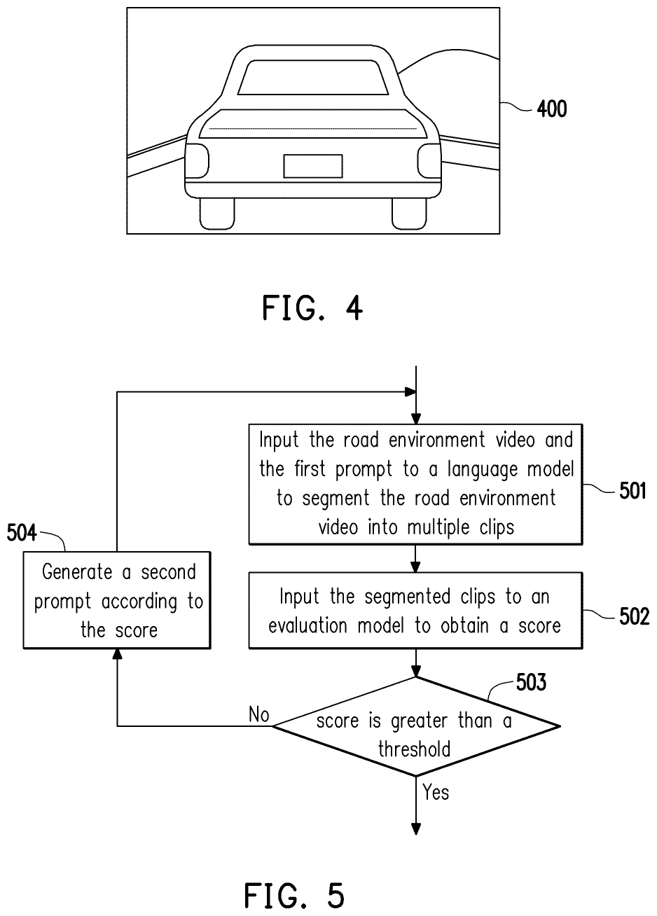

Since the road environment of concern differs in different modes, different prompts and test frames may be set. For example, FIG. 4 illustrates a test frame 400 in ACC mode, while the test frame may be an image captured from the rear of the intelligent vehicle 100 in reverse mode. The prompts will be explained together with the following step 303.

In step 303, the road environment video and the first prompt are input to a language model to segment the road environment video into multiple clips, where each clip contains multiple frames. This language model may be GPT (Generative Pretrained Transformer) series, BERT (Bidirectional Encoder Representations from Transformers) series, LLaMA (Large Language Model Meta AI), DeepSeek, Gemini, etc., but the invention is not limited to these. In some embodiments, the language model is a Multimodal Large Language Model (MLLM). In some embodiments, the prompt may include the driving mode and the direction of the image capturing device. For example, the prompt may be “Currently in ACC mode, camera direction is forward, please segment the video into multiple clips based on whether there are vehicles ahead.” If the current driving mode is reverse mode, the prompt may be “Currently in reverse mode, camera direction is backward, please segment the video into multiple clips based on whether there are vehicles behind.” Similarly, when the road environment video is from the left, right, or other directions, corresponding prompts may be generated.

In some embodiments, any driving conditions or environmental descriptions of the intelligent vehicle 100 may also be added to the prompt. For example, when the intelligent vehicle 100 is braking, the prompt may be “Currently in ACC mode, currently braking, camera direction is forward, please segment the video into multiple clips based on whether there are vehicles ahead.” When a sensor detect that it is raining, the prompt may be “Currently in ACC mode, it is raining outside, camera direction is forward, please segment the video into multiple clips based on whether there are vehicles ahead.” The aforementioned driving conditions and environmental descriptions may also include adjacent vehicle cutting in, rear-end collision, overtaking, etc. These prompts may be defined by users and can be freely edited, allowing more flexible use of environmental information and the processing capabilities of the language model, which is more adaptable to the conditions of the vehicle and environment compared to fixed segmentation algorithms.

FIG. 5 is a flowchart illustrating an alternative to step 303 according to another embodiment. Refer to FIG. 5, steps 501-504 may be used to replace the step 303. In step 501, the road environment video and the prompt are input to a language model to segment the road environment video into multiple clips, this step 501 is the same as the step 303. However, in the embodiment of FIG. 5, an evaluation model is also used to measure the segmentation performance. In step 502, the segmented clips are input to the evaluation model to obtain a score, this evaluation model may be another language model, or it may be any pre-trained neural network. In some embodiments, the start point, end point, and road environment video of each clip may be input to the evaluation model, or the road environment video and the separation points between two clips may be input to the evaluation model, or multiple video clips may be directly input to the evaluation model. This disclosure does not limit what type of data is used to represent these clips.

In step 503, it is determined whether the score is greater than a threshold. If yes, then the segmentation of the road environment video is complete and then it proceeds to the next step 304. If the result of step 503 is no, a second prompt is generated according to the score, for example, “The segmentation score is 60, please optimize the segmentation.” When the evaluation model is a language model, the evaluation model may also output the reason why the score is 60, and the output of the evaluation model may also be added to the second prompt. For example, the second prompt may be “The segmentation score is 60 because there are continuously appearing vehicles between the first clip and the second clip, please optimize the segmentation method.” Next, the step 501 is re-executed, the road environment video and the second prompt are input to the language model to re-segment the road environment video.

In such an embodiment, the segmentation step 501 will iterate multiple times until the score is greater than the threshold. In some embodiments, an iteration limit is set, and the iteration stops when the number of iterations exceeds this limit. Such an embodiment is equivalent to using the evaluation model as an optimizer, and using natural language to describe the segmentation results to optimize the segmentation results, which can perform optimization more precisely compared to known technology. In autonomous vehicles, there is a large amount of uncertain information, such as noise from multiple sensors and sudden situations of targets like pedestrians and vehicles. However, many optimization techniques are iterative: optimization starts with an initial solution and then iteratively updates the solution to optimize the objective function. Language models are to iteratively generate new solutions. The main advantage of language models in optimization is their ability to understand natural language, which allows people to describe their optimization tasks without formal specifications, such an advantage is more suitable for intelligent vehicles that handle complex functions and large amounts of uncertain information.

In some embodiments, the length of each clip is limited. If the length of the clip is too small, there is not enough information, and if the length is too long, it may include multiple scene changes. Therefore, the length limitation of the clip may be added to the prompt.

Refer to FIG. 3, in step 304, for a certain clip, a similarity between each frame in this clip and the test frame is calculated, thereby determining a first time point of the clip. For example, when the road environment video is about the front of the intelligent vehicle 100, the test frame is as shown in FIG. 4. When the similarity is greater than a threshold, it indicates that there is a vehicle in front, and the time point with the maximum similarity may be set as the first time point.

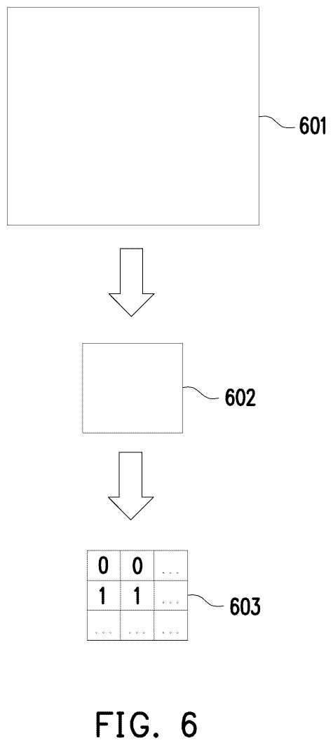

In some embodiments, a feature vector of the frame and a feature vector of the test frame may be calculated first, and then the similarity between these two feature vectors are calculated. FIG. 6 is a schematic diagram illustrating the calculation of feature vectors according to an embodiment. Refer to FIG. 6, for a frame 601 (also called the first frame) in the clip, this frame 601 may be reduced to a preset size to generate a frame 602. This preset size is, for example, 8*8 with only one channel (e.g. brightness). Next, the average of all pixels in the frame 602 is calculated, and then it is determined whether each pixel in the frame 602 is greater than this average to generate a bitmap 603. If the pixel is greater than the average, fill in “1” at the corresponding position in the bitmap 603; if the pixel is less than or equal to the average, fill in “0” at the corresponding position in the bitmap 603. Therefore, there are 64 bits in the bitmap 603, and then these 64 bits are combined to form a feature vector (also called the first feature vector).

For the test frame, the feature vector (also called the second feature vector) is calculated according to the process of FIG. 6. Next, the similarity between the first feature vector and the second feature vector is calculated. This similarity may be cosine similarity, Hamming distance, Euclidean distance, etc. If Hamming distance or Euclidean distance is used, the reciprocal of the distance may be calculated as the similarity.

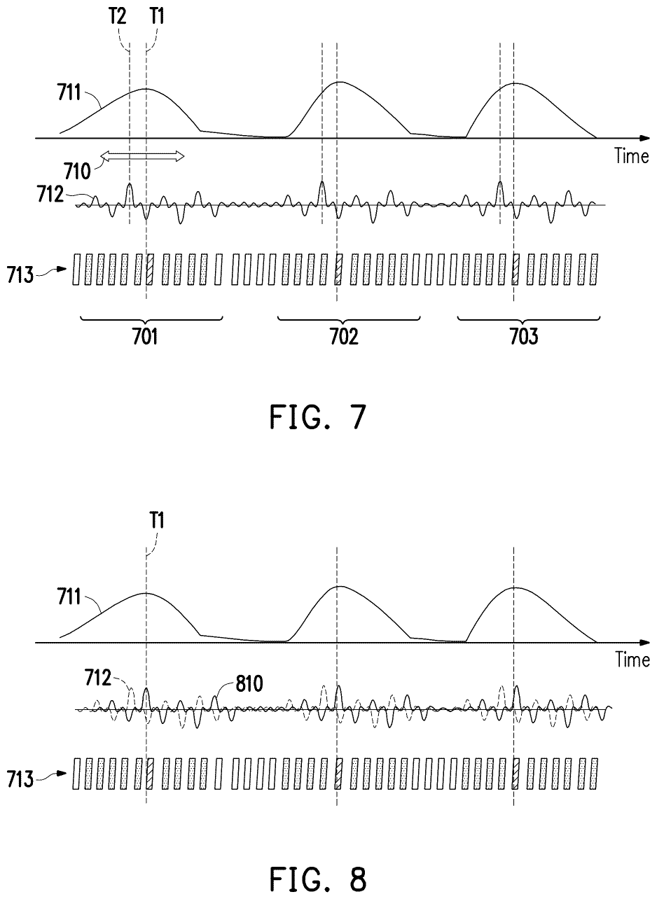

FIG. 7 is a schematic diagram illustrating the alignment of sensor data and road environment video according to an embodiment. Refer to FIG. 7 which illustrates multiple frames 713, that are divided into clips 701, 702, and 703. A curve 711 represents the probability of an object (for example, a vehicle in front) appearing in a clip, which in this embodiment is the similarity between the first feature vector and the second feature vector. From another perspective, the similarity at different time points may be called a time difference histogram, from which it can be seen that the similarity gradually increases and then decreases. Here, it is determined whether the similarity is greater than a threshold, and if so, the time point of the corresponding frame is set as the first time point T1. If there are multiple frames in a clip with similarities greater than the threshold, the time point T1 corresponding to the maximum similarity may be taken.

Refer to FIG. 3 and FIG. 7, in step 305, the sensor data is obtained through a sensor on the intelligent vehicle 100, and a one-dimensional signal is generated according to the sensor data. If the dimension of the sensor data itself is one (for example, representing the distance in front), the sensor data may be directly used as the one-dimensional signal. If the dimension of the sensor data is greater than 1 (for example, point cloud, or distances in multiple directions), the sensor data may be dimensionally reduced to obtain the one-dimensional signal. For example, principle component analysis (PCA) may be performed on sensor data at a certain time point to obtain a principal component vector, which is the eigen vector corresponding to the largest eigen value. Then the length of the principal component vector, such as the 2-norm, is calculated as the value of the one-dimensional signal at this time point. By performing the above calculation for each time point, values for multiple time points may be obtained, thereby composing a one-dimensional signal, such as the one-dimensional signal 712 in FIG. 7.

In step 306, within the window 710 at the first time point T1, an extreme value of the one-dimensional signal 712 is obtained while this extreme value occurs at a second time point T2. The window 710 is a time range representing a time error range of the sensor, and the first time point T1 is located at the center of the window 710. The extreme value mentioned above may be a maximum value or a minimum value, which is determined according to attributes of the one-dimensional signal 712. For example, when a larger value of the one-dimensional signal 712 indicates a closer distance between the vehicle in front and the intelligent vehicle 100, the time point of the maximum value may be set as the second time point T2.

In step 307, the road environment video and sensor data are aligned according to the first time point T1 and the second time point T2. For example, a difference between the first time point T1 and the second time point T2 is calculated, and then the road environment video or sensor data is time-shifted according to this difference. FIG. 8 is a schematic diagram illustrating the result after time shifting according to an embodiment. Here, the one-dimensional signal 712 is shifted forward on the time axis (the amount of movement is the same as the difference mentioned above), so the maximum value of the shifted one-dimensional signal 810 will align with the extreme value of curve 711.

For the sensor data captured by each sensor 231-233, the steps in FIG. 3 may be performed to align with the road environment video. The data alignment method mentioned above is based on driving mode and scene data for alignment, and uses a language model to process complex modes and environments, which can use sensor data more effectively and flexibly. For example, when driving in poor visibility weather and wanting to activate the ACC function, the driving mode may be set to ACC, and the scene (environment description) is “front vehicle in rainy weather”, “rear vehicle in rainy weather”, or “neighboring vehicles in rainy weather”. In such scenes, in addition to using the image capture module, radar needs to be added because radar performs more reliably than the image capture module in adverse weather and low light conditions. The above data alignment method needs to be performed on the image capture module and radar.

Although the present invention has been disclosed in the embodiments as above, it is not intended to limit the present invention. Any person with ordinary knowledge in the relevant technical field may make some modifications and refinements without departing from the spirit and scope of the present invention. Therefore, the protection scope of the present invention shall be defined by the appended claims.

What is claimed is:

1. A data alignment method for an intelligent vehicle, the data alignment method comprising:
obtaining a road environment video through an image capturing device on the intelligent vehicle;
determining a current driving mode from a plurality of driving modes of the intelligent vehicle, and determining a first prompt and a test image according to the current driving mode;
inputting the road environment video and the first prompt to a language model to segment the road environment video into a plurality of clips, wherein each of the clips comprises a plurality of frames;
for one of the clips, calculating a similarity between each of the corresponding frames and the test image, thereby determining a first time point of the segment;
obtaining sensor data through a sensor on the intelligent vehicle, and generating a one-dimensional signal according to the sensor data;
obtaining an extreme value of the one-dimensional signal in a window at the first time point, wherein the extreme value occurs at a second time point; and
aligning the road environment video and the sensor data according to the first time point and the second time point.

2. The data alignment method as claimed in claim 1, wherein the driving modes comprise an adaptive cruise control mode and a reverse mode.

3. The data alignment method as claimed in claim 1, further comprising:
inputting the clips to an evaluation model to obtain a score; and
if the score is less than or equal to a threshold, generating a second prompt according to the score, and inputting the road environment video and the second prompt to the language model to re-segment the road environment video.

4. The data alignment method as claimed in claim 1, wherein the step of calculating the similarity between each of the corresponding frames and the test image comprises:
for a first frame among the frames, reducing the first frame to a preset size to generate a second frame;
calculating an average of a plurality of pixels in the second frame;
determining whether the pixels are greater than the average to generate a first feature vector; and
calculating a similarity between the first feature vector and a feature vector of the test image.

5. The data alignment method as claimed in claim 4, further comprising:
determining whether the similarity between the first feature vector and the feature vector of the test image is greater than a threshold, and if so, setting a time point of the first frame as the first time point.

6. The data alignment method as claimed in claim 1, wherein the sensor comprises a radar or a lidar.

7. The data alignment method as claimed in claim 1, further comprising:
if a dimension of the sensed data is greater than 1, reducing the dimension of the sensed data to obtain the one-dimensional signal.

8. The data alignment method as claimed in claim 7, wherein the step of reducing the dimension of the sensed data to obtain the one-dimensional signal comprises:
performing a principal component analysis on the sensed data to obtain a principal component vector; and
for a time point, calculating a length of the principal component vector corresponding to the time point as a value of the one-dimensional signal at the time point.

9. The data alignment method as claimed in claim 1, wherein the step of aligning the road environment video and the sensed data according to the first time point and the second time point comprises:
calculating a difference between the first time point and the second time point; and
performing a time shift on the road environment video or the sensed data according to the difference.

10. The data alignment method as claimed in claim 1, wherein the first prompt comprises a direction of the image capturing device or an environment description.

11. An intelligent vehicle, comprising:
an image capturing device, configured to obtain a road environment video;
a sensor, configured to obtain sensed data; and
a processor, electrically connected to the image capturing device and the sensor, and configured to execute a plurality of steps:
obtaining the road environment video;
determining one current driving mode from a plurality of driving modes of the intelligent vehicle, and determining a first prompt and a test image according to the current driving mode;
inputting the road environment video and the first prompt to a language model to segment the road environment video into a plurality of clips, wherein each of the clips comprises a plurality of images;
for one of the clips, calculating a similarity between each of the corresponding images and the test image, thereby determining a first time point of the segment;
obtaining the sensed data, and generating a one-dimensional signal according to the sensed data;
in a window at the first time point, obtaining an extreme value of the one-dimensional signal, wherein the extreme value occurs at a second time point; and
aligning the road environment video and the sensed data according to the first time point and the second time point.

12. The intelligent vehicle as claimed in claim 11, wherein the driving modes comprise an adaptive cruise control mode and a reverse mode.

13. The intelligent vehicle as claimed in claim 11, wherein the steps further comprising:
inputting the clips to an evaluation model to obtain a score; and
if the score is less than or equal to a threshold, generating a second prompt according to the score, and inputting the road environment video and the second prompt to the language model to re-segment the road environment video.

14. The intelligent vehicle as claimed in claim 11, wherein the step of calculating the similarity between each of the corresponding images and the test image comprises:
for a first image in the images, reducing the first image to a preset size to generate a second image;
calculating an average of a plurality of pixels in the second image;
determining whether the pixels are greater than the average to generate a first feature vector; and
calculating a similarity between the first feature vector and a feature vector of the test image.

15. The intelligent vehicle as claimed in claim 14, wherein the steps further comprising:
determining whether the similarity between the first feature vector and the feature vector of the test image is greater than a threshold, if yes, setting a time point of the first image as the first time point.

16. The intelligent vehicle as claimed in claim 11, wherein the sensor comprises a radar or a lidar.

17. The intelligent vehicle as claimed in claim 11, wherein the steps further comprising:
if a dimension of the sensor data is greater than 1, reducing the dimension of the sensor data to obtain the one-dimensional signal.

18. The intelligent vehicle as claimed in claim 17, wherein the step of reducing the dimension of the sensor data to obtain the one-dimensional signal comprises:
performing a principal component analysis on the sensor data to obtain a principal component vector; and
for a time point, calculating a length of the principal component vector corresponding to the time point to serve as a value of the one-dimensional signal at the time point.

19. The intelligent vehicle as claimed in claim 11, wherein the step of aligning the road environment video and the sensor data according to the first time point and the second time point comprises:
calculating a difference between the first time point and the second time point; and
performing a time shift on the road environment video or the sensor data according to the difference.

20. The intelligent vehicle as claimed in claim 11, wherein the first prompt comprises a direction of the image capturing device or an environment description.
